(19) United States
(12) Patent Application Publication
(10) Pub. No.: US 2005/0196140 A1
(43) Pub. Date: Sep. 8, 2005

(54) Information recording and reproducing apparatus and information recording and reproducing method

(75) Inventor: Masataka Moteki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/062,453

(22) Filed: Feb. 22, 2005

(30) Foreign Application Priority Data
Mar. 4, 2004 (JP) 2004-061459

(51) Int. Cl. H04N 5/76

(52) U.S. Cl. 386/52; 386/125

(57) ABSTRACT

An information recording and reproducing apparatus for dubbing content, where the rate of the content is converted, reads and decodes content in a dubbing source, encodes the decoded content at a predetermined conversion rate, and produces content in a dubbing destination. The information recording and reproducing apparatus then verifies an entry point associated with the content in the dubbing source and assigns the verified entry point to the content in the dubbing destination and record to the dubbing destination. Thus, the entry point can be copied from content in the dubbing source to the dubbing destination during rate-conversion dubbing, and information set as reference information about content in the dubbing source such as chapter information is transferred to the dubbing destination.

### CROSS-REFERENCE TO RELATED APPLICATIONS

This application is based upon and claims the benefit of priority from the prior Japanese Patent Application No. 2004-61459 filed on Mar. 4, 2004; the entire contents of which are incorporated herein by reference.

### BACKGROUND OF THE INVENTION

1. Field of the Invention

The present invention relates to an information recording and reproducing apparatus and an information recording and reproducing method where content, such as video data, recorded on an information recording medium (hereinafter referred to just as a medium) in a dubbing source can be recorded (copied) on a medium in a dubbing destination.

2. Description of Related Art

Nowadays, digital video recording and reproducing apparatuses have been developed that are provided with a magnetic disk unit such as a hard disk drive (hereinafter referred to as an HDD) and an optical disk unit such as a DVD-RAM drive to record information, such as digital moving images compressed based on MPEG standards, on the magnetic disk or the optical disk and furthermore to reproduce the information from the magnetic disk or the optical disk.

Because such a digital video recording and reproducing apparatus is provided with two recording units: a magnetic disk unit and an optical disk unit, content such as digital moving image information can be record on the magnetic disk temporarily, and at a later time the digital moving image information can be dubbed (copied) from the magnetic disk to the optical disk.

For example, Japanese Unexamined Patent Application Publication No. 2002-150672 discloses an apparatus and a method for recording information that completes dubbing (copying) processing in a short time while still checking for illegal copying. More specifically, in the information recording apparatus and method disclosed in Japanese Unexamined Patent Application Publication No. 2002-150672, when information, such as video/audio data, is to be recorded on the magnetic disk, the main processor unit (MPU) saves, in a copy control information file on the magnetic disk of the HDD unit, digital watermark information detected by the encoder and copy control information, such as additional information, in accordance with the Copy Generation Management System (CGMS). According to Japanese Unexamined Patent Application Publication No. 2002-150672, for dubbing processing, the MPU reads out copy control information about recorded data from the copy control information file, and then if the copy control information about the recorded data for which dubbing processing has been specified indicates “Copy Permitted (Copy Free)”, the recorded data is copied from the magnetic disk to the optical disk, such as a DVD-RAM, without decoding/re-encoding processing. In contrast, if the copy control information indicates that copying is protected, the recorded data is decoded and the copy control information is checked to cancel the dubbing processing.

There are two types of dubbing processing. According to one type of dubbing processing, video data recorded on a medium is copied as-is to another medium. Since this type of dubbing allows the video data to be copied in a shorter period of time than the actual playback time of the video data, it is called fast dubbing.

The other type of dubbing processing is called rate-conversion dubbing. This type of dubbing processing is used for the purposes described below. First, the rate-conversion dubbing is used to adjust to the capacity of the medium in the dubbing destination. For example, when content whose data volume exceeds the recording capacity of a DVD-RAM is to be copied to the DVD-RAM, the data volume of the content is decreased so that the data volume is adjusted to the capacity of the DVD-RAM. Second, the rate-conversion dubbing is used to smoothly reproduce image data that has been edited. Image data that has been edited, such as image data in which parts have been registered or from which parts have been deleted, has a discontinuous area of image data at such edited points. The term “rate” here indicates the mean amount of information per unit time.

Rate-conversion dubbing is carried out as follows. That is, MPEG video data of content recorded on the medium in the dubbing source is read and decoded, and subsequently the decoded data is re-encoded into an MPEG stream, which is then recorded on a medium in the dubbing destination. For this reason, rate-conversion dubbing has a problem such that information set in the dubbing source as reference information about content in the dubbing source, such as an entry point defined in accordance with the DVD-VR standard, is lost, i.e., is not copied to the dubbing destination.

Let us assume a video recording and reproducing apparatus where the unit composed of video data sequences, for example, from the start to the end of video recording is defined as a title and segments called chapters are defined in that title. It is also presumed that entry points (EPs) defined in accordance with the DVD-VR standard are used as marks for identifying the boundaries between chapters, i.e., segments in the title. In this video recording and reproducing apparatus, if an entry point defined in accordance with the DVD-VR standard is not copied to the dubbing destination during rate-conversion dubbing as described above, the corresponding chapter is also lost, i.e., is not copied to the dubbing destination.

### BRIEF SUMMARY OF THE INVENTION

It is, therefore, an object of the present invention is to provide an information recording and reproducing apparatus and an information recording and reproducing method where, during rate-conversion dubbing, information set as reference information about content in the dubbing source, such as a chapter, can be copied to the dubbing destination for the sake of the user's convenience.

According to a first aspect of the present invention, an information recording and reproducing apparatus for dubbing content, where the rate of the content is converted, includes a section which decodes content in a dubbing source; a section which encodes the decoded content at a predetermined conversion rate and produces content in a dubbing destination; a section which verifies an entry point associated with the content in the dubbing source; and a section which associates the verified entry point with the content in the dubbing destination.

According to a second aspect of the present invention, an information recording and reproducing apparatus for dubbing actual video data of a first title as actual video data of a second title, where the rate of the actual video data of the first title is converted, includes a section which decodes the actual video data of the first title; a section which encodes the decoded actual video data at a predetermined conversion rate and produces the actual video data of the second title; a section which obtains information about a relative position of first point information, functioning as a mark, in the first title based on reference information referring to the actual video data of the first title; and a section which establishes second point information, functioning as a mark, in the second title based on the obtained information about the relative position of the first point information wherein the second point information is associated with reference information referring to the actual video data of the second title.

According to a third aspect of the present invention, an information recording and reproducing method for dubbing content, where the rate of the content is converted, includes the steps of decoding content in a dubbing source; encoding the decoded content at a predetermined conversion rate and producing content in a dubbing destination; verifying an entry point associated with the content in the dubbing source; and associating the verified entry point with the content in the dubbing destination.

According to the present invention, it is possible to provide an information recording and reproducing apparatus and an information recording and reproducing method where, during rate-conversion dubbing, information set as reference information about content in the dubbing source, such as a entry point in accordance with the DVD-VR standard, can be copied to the dubbing destination for the sake of the user's convenience.

### BRIEF DESCRIPTION OF THE DRAWINGS

FIG. 1 is a diagram depicting the structure of an information recording and reproducing apparatus according to an embodiment of the present invention;

FIG. 2 is a diagram depicting the relationship between management information and actual video data according to the present invention;

FIG. 3 is a schematic diagram depicting the basic concept of the main part of the present invention, where an entry point is set in a title based on the position of an entry point in another title;

FIG. 4 is a flowchart depicting the operation of rate-conversion dubbing according to the present invention;

FIG. 5 is a schematic diagram depicting the processing for setting an entry point shifted by an offset in a title based on the position of an entry point in another title;

FIG. 6 is a flowchart of processing for obtaining the position where an entry point is set in a title and for setting an entry point in another title based on the obtained position;

FIG. 7 is a flowchart of processing detail for calculating the position where an entry point is set in a title; and

FIG. 8 is a flowchart of processing detail for obtaining the position where an entry point is set in a title and for setting an entry point in another title based on the obtained position.

### DETAILED DESCRIPTION OF THE INVENTION

Embodiments according to the present invention will now be described with reference to the drawings.

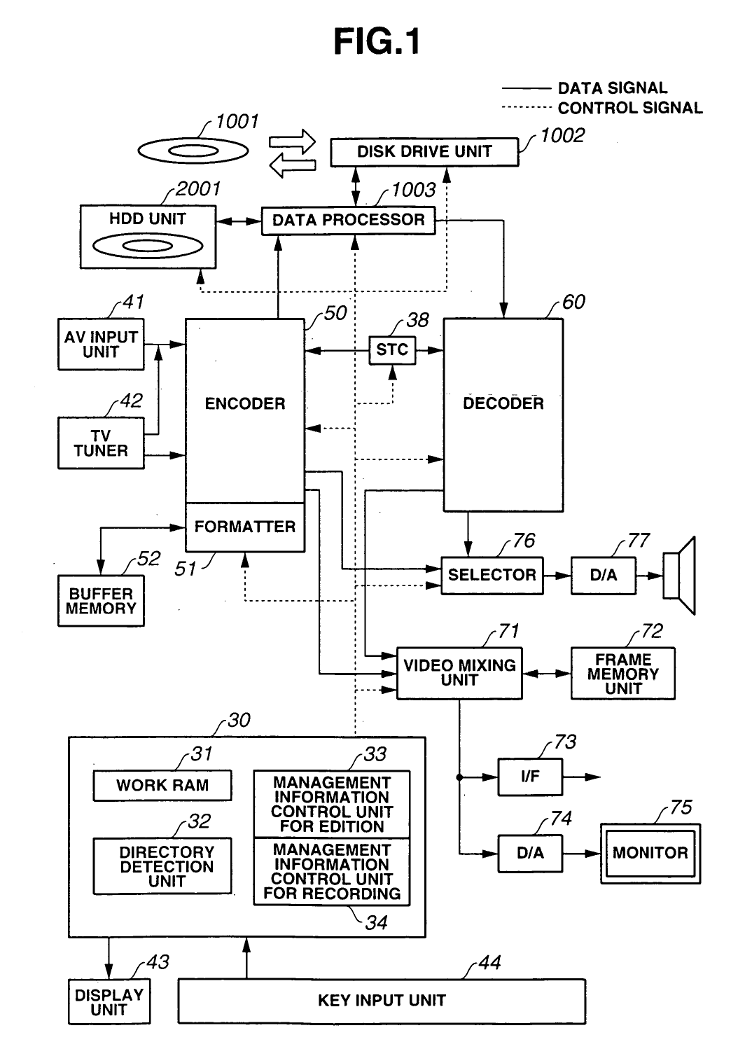

FIG. 1 is a drawing depicting the structure of an information recording and reproducing apparatus according to an embodiment of the present invention. Although in this embodiment the information recording and reproducing apparatus can use both a hard disk and a DVD-RAM as recording media, the hard disk or the DVD-RAM can be replaced with another recording medium such as a semiconductor memory.

The block structure in FIG. 1 is roughly divided into two sections: a recording section in the left half in FIG. 1 and a reproducing section in the right half in FIG. 1.

The information recording and reproducing apparatus in FIG. 1 has two types of disk drive units. One disk drive unit is a hard disk drive unit (HDD unit) 2001 that drives a hard disk, functioning as a first medium (information recording medium), where a video file can be produced. The other disk drive unit is a disk drive unit 1002 that rotationally drives an optical disk 1001, functioning as a second medium (information recording medium), where a video file can also be produced so that information can be read from and written to the optical disk 1001.

A data processor 1003 can supply recorded data to the disk drive unit 1002 and the hard disk drive unit 2001 and can receive a reproduced signal. The disk drive unit 1002 has a rotation control system, a laser drive system, an optical system, etc. for the optical disk 1001.

The data processor 1003 processes data for each session of recording or reproducing, and includes a buffer circuit, a modulation/demodulation circuit, an error correction unit, etc.

The information recording and reproducing apparatus in FIG. 1 further includes as main components an encoder 50 constituting the video recording section, a decoder 60 constituting the reproducing section, and a microcomputer block 30 for controlling the operation of the main body of the apparatus.

The encoder 50 includes a video analog-to-digital converter and an audio analog-to-digital converter that respectively digitize an input analog video signal and an input analog audio signal. The encoder 50 further includes a video encoder, an audio encoder, and a sub-video encoder.

The output of the encoder 50 is converted into a predetermined DVD-RAM format by a formatter 51 including a buffer memory 52, and is then supplied to the above-described data processor 1003.

The encoder 50 receives external analog video and audio signals from an AV input unit 41 or analog video and audio signals from a TV tuner 42.

If the encoder 50 directly receives a compressed digital video signal and digital audio signal, the compressed digital video signal and digital audio signal can be supplied directly to the formatter 51. Furthermore, the encoder 50 can supply digital video and audio signals that have been subjected to analog-to-digital conversion directly to a video-mixing unit 71 and an audio selector 76.

The video encoder included in the encoder 50 converts a digital video signal into a digital video signal compressed at variable bit rates in accordance with the MPEG2 or MPEG1 standard. A digital audio signal is converted into a digital audio signal compressed at a fixed bit rate based on the MPEG or AC-3 standard, or into a digital audio signal based on the linear PCM.

If a sub-video signal is input from the AV input unit 41 (e.g., a signal from a DVD video player with an independent output terminal for sub-video signal) or if a broadcast DVD video signal with a sub-video signal is input to the TV tuner 42, then the sub-video signal in the DVD video signal is encoded (run-length encoded) by the sub-video encoder into sub-video bit map data.

The encoded digital video signal, digital audio signal, and sub-video data are packed by the formatter 51 into a video pack, an audio pack, and a sub-video pack, respectively. Furthermore, these packs are collected into a format specified in compliance with the DVD-VR standard (e.g., a standard for recording on a DVD-RAM or DVD-RW).

The apparatus shown in FIG. 1 supplies information formatted by the formatter 51 (e.g., video, audio, and sub-video data packs) and generated management information via the data processor 1003 to hard disk drive (HDD) unit 2001 or the disk drive unit 1002 to record the information on the hard disk or the optical disk 1001. In addition, information recorded on the hard disk can be recorded on the optical disk 1001 or information recorded on the optical disk 1001 can be recorded on the hard disk via the data processor 1003 and the disk drive unit 1002.

Furthermore, data editing, such as partially deleting a video object containing a plurality of programs recorded on the hard disk or the optical disk 1001 or merging objects containing different programs, can be performed. Such data editing can be performed easily because the basic unit of data manipulated in the format according to the present invention is defined.

The microcomputer block 30 includes either of a micro-processing unit (MPU) and a central processing unit (CPU), a ROM to which a control program or the like is written, and a RAM for providing a work area required to execute such a control program.

The MPU of the microcomputer block 30 uses the RAM as a work area according to the control program stored in the ROM to carry out various operations such as detecting defective sectors, detecting unrecorded areas, setting a position where video recording information is recorded, recording a Universal Disk Format (UDF), and setting an AV address.

The microcomputer block 30 further includes information processing units required to control the entire system, such as a work RAM 31, a directory detection unit 32, a VMG information (video management information about the entire volume) generation unit, a copy-related information detection unit, a copying and scrambling information processing unit (RDI processing unit), a packet header processing unit, a sequence header processing unit, and an aspect-ratio information processing unit. These information detection unit, information generation unit, and information processing unit are realized by arithmetic operations by the MPU and the control program in the ROM.

The microcomputer block 30 further includes a control unit 34 for controlling management information at the time of video recording and a control unit 33 for controlling management information at the time of editing. These control units 33 and 34 are realized by arithmetic operations by the MPU and the control program in the ROM. Means according to an aspect of the present invention is executed by this control unit 33 in the form of the control program.

From among the results of processing by the MPU in the microcomputer block 30, information to be reported to the user is displayed on a display unit 43 of the information recording and reproducing apparatus or is subjected to on-screen display (OSD) on a monitor 75. Furthermore, the microcomputer block 30 is connected to a key input unit 44 that supplies an operation signal for operating this apparatus. This key input unit 44 corresponds to, for example, operation switches provided on the main body of the information recording and reproducing apparatus or a remote control unit. In addition, the key input unit 44 may be a personal computer connected to the information recording and reproducing apparatus according to the present invention by means of wired communication, wireless communication, optical communication, or infrared communication. Whatever type is used for the key input unit 44, the user operates this key input unit 44 to perform various operations, such as recording input video and audio signals, reproducing recorded content, stopping recorded content, performing time-slip transactions such as chase reproduction of recorded content, and editing recorded content.

The microcomputer block 30 controls the disk drive unit 1002, hard disk drive unit 2001, data processor 1003, encoder 50 and/or decoder 60 based on the time data from a system time clock (STC) 38. Video recording and reproducing operations are generally performed in synchronization with the time clock from the STC 38. Other operations, however, may be performed with timing independent of the time clock from the STC 38.

The decoder 60 includes a separator that extracts each pack from a pack-structured signal in the DVD format, a memory used for pack extraction and other signal processing, a video decoder that decodes main video data (content of video pack) extracted by the separator, a sub-video decoder that decodes sub-video data (content of sub-video pack) extracted by the separator, and an audio decoder that decodes audio data (content of audio pack) extracted by the separator. The decoder 60 further includes a video processor that combines decoded main video and decoded sub-video as necessary and superimposes a menu, a highlight button, a caption, and other sub-video data on the main video data.

An output video signal of the decoder 60 is input to the video mixing unit 71. In the video mixing unit 71, video data is combined with text data. A line for directly receiving a signal that has passed through the encoder 50 from the TV tuner 42 or the A/V input unit 41 is also connected to the video mixing unit 71. A frame memory unit 72 used as a buffer is connected to the video mixing unit 71. If the output of the video mixing unit 71 is an analog output, it is externally output via an interface (I/F) 73. If the output of the video mixing unit 71 is a digital output, it is externally output via a digital-to-analog converter (abbreviated as a D/A) 74.

An output audio signal of the decoder 60 is converted into an analog signal by a digital analog converter 77 via the selector 76 and is externally output. The selector 76 is controlled by the select signal from the microcomputer block 30. Thus, when a digital signal from the TV tuner 42 or the A/V input unit 41 is directly monitored, the selector 76 can select the audio signal that has passed through the encoder 50.

In the formatter 51 of the encoder 50, various isolation information items are generated during video recording and periodically sent to the MPU of the microcomputer block 30. Isolation information includes information added to, for example, the head of a GOP, the number of packs in a video object unit (VOBU), the end address of an I picture relative to the top of the VOBU, the reproducing time of the VOBU, etc.

The microcomputer block 30 also sends information from the aspect information processing unit to the MPU when video recording is started, and the MPU then generates video object (VOB) stream information (STI). As the STI, for example, resolution data and aspect data are saved, so that the decoder 60 performs initial setting based on these resolution data and aspect data items at the time of reproducing.

Furthermore, this apparatus presumes that one disk contains one video file. In addition, the minimum contiguous information unit (size) is defined to prevent reproducing from being interrupted while data is accessed or seek is carried out. This information unit is called a contiguous data area (CDA). The CDA size is a multiple of the size of an error correction code (ECC) block (16 sectors). According to the file system, information is recorded in units of this CDA.

The data processor 1003 receives data in units of VOBU from the formatter 51 of the encoder 50, and supplies data in units of CDA to the disk drive unit 1002 or the hard disk drive unit 2001.

Furthermore, the MPU of the microcomputer block 30 generates management information required to reproduce recorded data, and when a command for stopping data recording is detected, the MPU sends the generated management information to the data processor 1003. As a result, the management information is recorded on the disk. Thus, during encoding, the MPU of the microcomputer block 30 receives information from the encoder 50 in units of data (e.g., isolation information).

Furthermore, when recording is started, the MPU of the microcomputer block 30 recognizes management information (file system) read from the optical disk 1001 and the hard disk to detect an unrecorded area on each disk, and sets a data recording area on each disk via the data processor 1003.

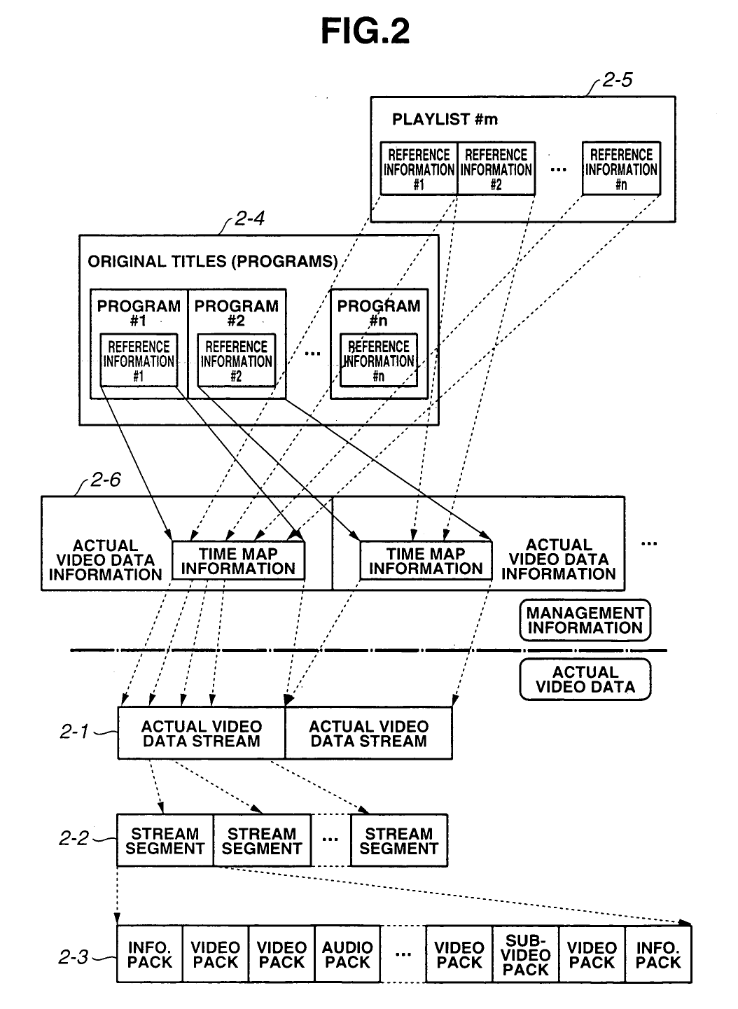

The relationship between management information and content, i.e., actual video data, will now be described briefly with reference to FIG. 2.

Actual video data is first described with reference to FIG. 2. In the current description, it is presumed that actual video data is contained in a single file on a recording medium. One file includes one or more actual video data streams 2-1. Each of the actual video data streams 2-1 is a unit of data corresponding to, for example, one video recording operation. The actual video data stream 2-1 corresponds to, for example, a video object (VOB) in accordance with the DVD-VR standard. One actual video data stream 2-1 includes one or more stream segments 2-2. A stream segment 2-2 corresponds to, for example, a video object unit (VOBU) in accordance with the DVD-VR standard or a group of pictures (GOP) in accordance with the MPEG2 standard. One stream segment 2-2 includes a plurality of packs 2-3. These packs 2-3 include an information pack, a video pack, an audio pack, etc. A sub-video pack may be included.

An information pack corresponds to, for example, a copying and scrambling information (RDI) pack in accordance with the DVD-VR standard. In this case, this information pack includes, for example, information indicating the start time at which the first field in the VOBU containing this information pack is reproduced, information indicating the time at which the VOBU in question is recorded, and information regarding the manufacturer (MNFI). This information pack further includes display control information (DCI) and copy control information (CCI). The display control information represents aspect-ratio information, subtitle mode information, and film camera mode information. The copy control information includes copy-permitted information or copy-protected (prohibited) information.

A video pack is video data compressed in accordance with the MPEG2 scheme, and includes a pack header, a packet header, and a video data section.

An audio pack is audio data that has been processed in accordance with, for example, the linear PCM, MPEG, or AC-3 scheme. It includes a pack header, a packet header, and an audio data section.

The management information will now be described.

Management information includes original title (program) information 2-4, actual video data information 2-6, and playlist information 2-5.

The original title (program) information 2-4 manages the reproducing order of actual video data (reproducing order information). The original title (program) information 2-4 corresponds to, for example, a program in accordance with the DVD-VR standard.

The original title information (program information) 2-4 has reference information defined. This reference information is linked with actual video data information 2-6 that is information regarding actual video data to be reproduced. This reference information also includes information regarding an entry point (EP), which is to be described later. The reference information corresponds to, for example, a cell and video object information (VOBI) in accordance with the DVD-VR standard.

As described above, an original title (program) includes information for managing the reproducing order (reproducing order information) and its own actual video data. In general, this original title is generated when video recording is performed.

In contrast, some information includes information for managing the reproducing order (reproducing order information) only. The playlist information 2-5, which corresponds to, for example, the playlist in accordance with the DVD-VR standard, includes reproducing order information only.

This playlist information 2-5 does not include its own actual video data, and as is denoted by playlist information 2-5 in FIG. 2, is generated as a playlist by editing (deleting or adding) reference information linked with the actual video data information 2-6 of the original title.

Information regarding actual video data, which is denoted by actual video data information 2-6, includes time map information. This time map information specifies a stream segment 2-2 that constitutes the actual video data stream 2-1 corresponding to the actual video data information 2-6. A link from the reference information of the original title information 2-4 or the playlist information 2-5 in the management information to the actual video data information 2-6 is identified with a logical address. Furthermore, a link from the time map information to the actual video data stream 2-1 and its segment 2-2 is established based on the number of the actual video data stream 2-1, the number of stream segments 2-2 in the stream 2-1, the entry number for each stream segment 2-2, and the logical address to each stream segment 2-2.

With the above-described structure, not only normal reproducing of recorded video data but also special reproducing, such as double-speed/slow reproducing and backward reproducing can be supported, and furthermore, a search can be made for a particular scene.

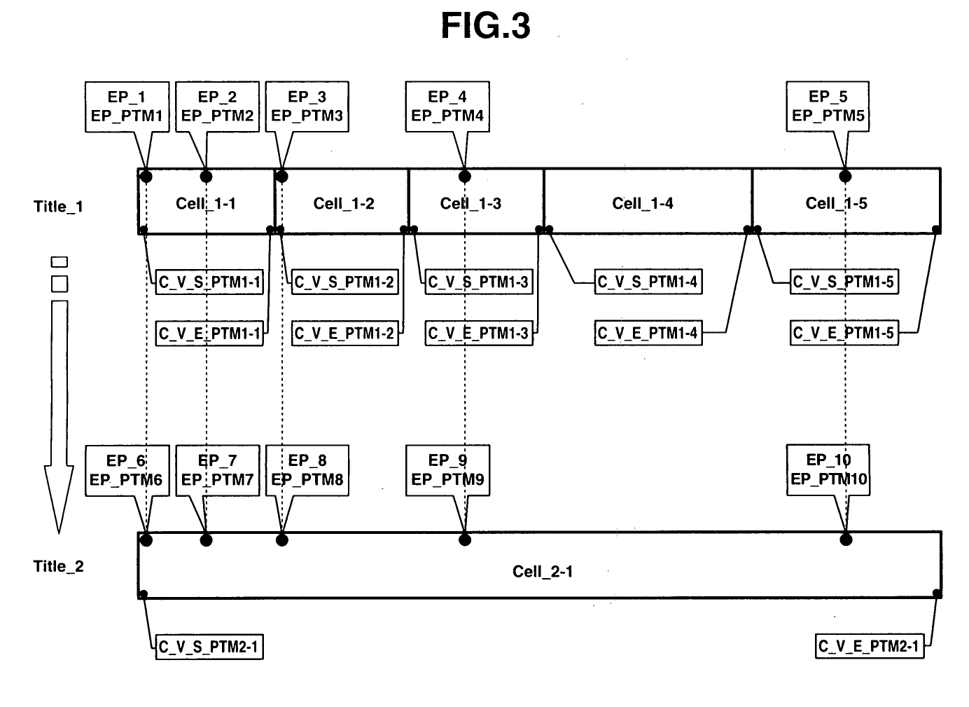

The operation of the information recording and reproducing apparatus according to an embodiment of the present invention will be described with reference to the drawings in FIG. 3 and the subsequent figures. In the description of the operation, it is presumed that the information recording and reproducing apparatus has the following structure.

First, the information recording and reproducing apparatus according to the present invention is a DVD video recording and reproducing apparatus in compliance with the DVD video recording standard (DVD-VR standard). Furthermore, the information recording and reproducing apparatus is a hybrid recording and reproducing apparatus with two video recording media: a DVD and an HDD, where dubbing of video information is possible between the DVD and the HDD. In addition, for video recording on the DVD, the information recording and reproducing apparatus has a function for recording video data on a DVD-RAM based on the DVD-VR standard, as well as a function for recording video data on a DVD-R and a DVD-RW based on the DVD video standard (DVD-Video standard).

Furthermore, in the information recording and reproducing apparatus according to the present invention, a segment in a title generated by video recording is called a chapter. In addition, a chapter uses an entry point (EP) defined in accordance with the DVD-VR standard and set in the title as a mark for identifying the boundary thereof. In short, a segment between EPs set in the title is called a chapter. Further, the start point and the end point of a title are defined as boundaries of a chapter, whether an EP exists or not. Thus, the first chapter of a title need not have an EP set at the start point.

FIG. 3 is a diagram depicting the basic concept of the main part of the present invention. Rate-conversion dubbing is performed with the title of a first medium as “Title_1” and the title of a second medium as “Title_2”. In this example in FIG. 3, the title “Title_1” has five entry points (EPs), “EP_1” to “EP_5”, in accordance with the DVD-VR standard. Based on the information about the positions of these five EPs from “EP_1” to “EP_5” in the title “Title_1”, five EPs from “EP_6” to “EP_10” are set in the other title “Title_2”.

Regarding the cells in compliance with the DVD-VR standard in the example in FIG. 3, “Title_1” includes five cells “Cell_1-1” to “Cell_1-5”. On the other hand, “Title_2” includes only one cell “Cell_2-1”. Although the Presentation Time (PTM) is contiguous from the cell start point to the cell end point of each of the five cells included in “Title_1”, the PTM is generally discontinuous at cell boundaries. In FIG. 3, “EP_PTM1” to “EP_PTM5” represent PTMs at the positions where “EP_1” to “EP_5” are set respectively. They are just PTMs in the cells including the corresponding EPs, and do not indicate absolute positions in “Title_1” where the PTMs are discontinuous at cell boundaries.

Therefore, in this case, the position of each of the five EPs “EP_1” to “EP_5” is calculated as a distance relative to the start of “Title_1”, more specifically, as a PTM difference. The five EPs “EP_6” to “EP_10” are set at such positions that the PTM differences from the start of “Title_2” are equivalent to the respective PTM differences of “EP-1” to “EP_5” from the start of “Title_1”.

This mechanism is described below in more detail. Provided that “Diff(EP_n)” represents the PTM difference from the start of the title to the position where “EP_n” (n-th EP) is set, the processing begins by calculating the PTM difference from the start of “Title_1” to each of the five EPs “EP_1” to “EP_5”, as follows. Here, it is presumed that “EP_1” and “EP_3” are set at the starts of the respective cells. In the following expressions, “C_V_S_PTMx-y” represents the PTM at the start of a cell, and “C_V_E_PTMx-y” represents the PTM at the end of the cell.
Diff(EP_1)=0
Diff(EP_2)=(“EP_PTM2“−”C_V_S_PTM11-1”)
Diff(EP_3)=(“C_V_E_PTM1-1“−”C_V_S_PTM1-1”)
Diff(EP_4)=(“C_V_E_PTM1-1“−”C_V_S_PTM1-1”)+(“C_V_E_PTM1-2“−”C_V_S_PTM1-2”)+(“EP_PTM4“−”C_V_S_PTM1-3”)
Diff(EP_5)=(“C_V_E_PTM1-1“−”C_V_S_PTM1-1”)+(“C_V_E_PTM1-2“−”C_V_S_PTM1-2”)+(“C_V_E_PTM1-3”−“C_V_S_PTM1-3”)+(“C_V_E_PTM1-4“−”C_V_S_PTM1-4”)+(“EP_PTM5”−“C_V_S_PTM1-5”)

Next, the five EPs “EP_6” to “EP_10” in “Title_2” are set at the positions corresponding to the PTMs that are obtained from the above-described “Diff(EP_1)” to “Diff(EP_5)”, respectively. Here, if it is presumed that “Title_2” includes only one cell “Cell_2-1” and the five cells “EP_6” to “EP_10” are included in “Cell_2-1”, “EP”_PTM6” to “EP_PTM10”, which are the PTMs at the positions where the five EPs “EP_6” to “EP_10” are set, are obtained as follows.
EP_PTM6=“C_V_S_PTM2-1”+Diff(EP_1)
EP_PTM7=“C_V_S_PTM2-1”+Diff(EP_2)
EP_PTM8=“C_V_S_PTM2-1”+Diff(EP_3)
EP_PTM9=“C_V_S_PTM2-1”+Diff(EP_4)
EP_PTM10=“C_V_S_PTM2-1”+Diff(EP_5)

In this manner, the five EPs “EP_6” to “EP_10” can be set in “Title_2” based on the information regarding the position of each of the five EPs “EP-1” to “EP_5” in “Title_1”.

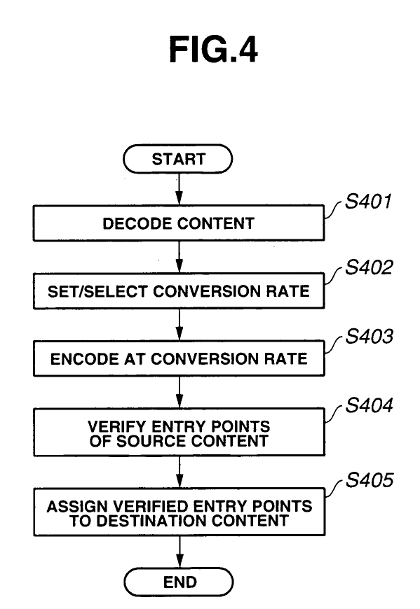

FIG. 4 is a flowchart depicting the operation of rate-conversion dubbing according to the present invention. In rate-conversion dubbing according to the present invention, when data recorded on the first medium is to be dubbed (copied) onto the second medium based on the relationship between the above-described entry points (EPs) and chapters, the chapters included in the data recorded on the first medium can be transferred (copied) to the data on the second medium.

Referring to FIGS. 1 and 4, when a dubbing command is received from the MPU of the microcomputer block 30 according to an instruction for rate-conversion dubbing based on an operation of the key input unit 44, the HDD unit 2001 reads out from the first medium (hard disk) the recorded data of the dubbing source (title) for which dubbing has been specified by the user and supplies the recorded data (MPEG stream) to the data processor 1003. The data processor 1003 supplies the decoder 60 with the recorded data (MPEG stream) passed from the HDD unit 2001.

The decoder 60 decodes (restores) the MPEG stream supplied by the data processor 1003 to generate the original recorded data (step S401).

Next, a setting screen for setting the conversion rate that determines the image quality appears on the display unit 43, where the user operates cursor keys and the Enter key on the key input unit 44 to select and set a conversion rate (step S402). The flow then proceeds to step S403.

In step S403, the above-described decoded content is supplied to the encoder 50 via the data processor 1003 and is then encoded at the selected conversion rate (compression encoding) to generate content to be recorded (copied) onto the second medium (optical disk 1001) in the dubbing destination.

In the sequence described above, step S402 where the user selects and sets a conversion rate can be omitted. More specifically, when the content in the dubbing source is decoded in step S401, the flow may automatically proceed to step S403, where the encoder 50 encodes the content at a predetermined conversion rate (compression encoding) to generate the content to be recorded (copied) onto the second medium in the dubbing destination.

Thereafter, the flow proceeds to steps S404 and S405. In step S404, the MPU of the microcomputer block 30 reads out, via the data processor 1003, the entry points (EPs) of the content recorded on the first medium (hard disk) in the dubbing source to verify the EPs. Next, in step S405, the verified EPs are assigned to the content in the dubbing destination via the data processor 1003 and the disk drive unit 1002 to transfer (copy) the EPs to the second medium (optical disk 1001).

The processing described with reference to the flowchart in FIG. 4 is interpreted as follows if it is described according to the actual video data and the reference information shown in FIG. 2. That is, after the actual video data of the first title recorded on the first medium has been decoded, the decoded actual video data is encoded at a predetermined conversion rate or at a conversion rate selected by the user to generate actual video data for the second title to be recorded on the second medium. Then, information about the relative position in the first title, for which a first entry point information is indicated as marks, is calculated based on the reference information referring to the actual video data of the first title recorded on the first medium. Thereafter, using the information about the calculated relative position of the first entry point in the first title, a second entry point is set as a mark for the second title to record (copy) it onto the second medium such that the second entry point is associated with the reference information referring to the actual video data of the second title to be recorded on the second medium.

In this manner, the entry points (EPs) of the recorded data on the first medium are transferred to the recorded data to be copied onto the second medium.

In the above-described example, the entry points (EPs) are read out for verification from the content on the hard disk 2001 in the dubbing source via the data processor 1003, and then the entry points (EPs) are allocated to the content on the optical disk 1001 in the dubbing destination via the data processor 1003 and the disk drive unit 1002. Instead of the above-described strategy, it is also possible to pre-load the management information shown in FIG. 2 into the work RAM 31 of the microcomputer block 30 in FIG. 1, so that the entry points (EPs) are verified and allocated from the content reference information of the dubbing source in the work RAM 31 to that in the dubbing destination, and subsequently the management information is written back to the hard disk 2001 and the optical disk 1001, as appropriate.

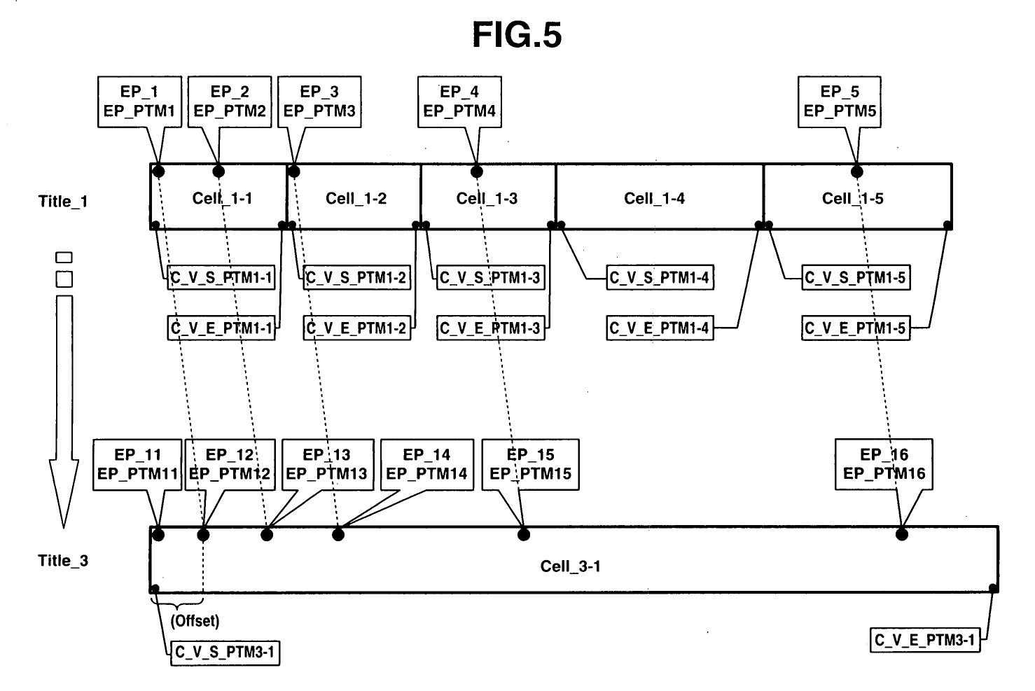

FIG. 5 is another drawing depicting the basic concept according to the present invention. FIG. 5 represents a modification of the basic concept depicted in FIG. 3. In the example shown in FIG. 5, an offset is applied to the position where an EP is set in “Title_3”.

Here, it is presumed that “Title_3” is generated by applying rate-conversion dubbing to “Title_1”. In the case of rate-conversion dubbing, it is common that AV data of the content in the dubbing source is decoded, and this decoded content is re-encoded at a predetermined conversion rate or at a conversion rate selected by the user to generate the content for the dubbing destination. In this case, the EPs set in the title in the dubbing source are ignored and therefore are not transferred to the dubbing destination. In such a case, the information recording and reproducing apparatus according to the present invention, as illustrated in FIG. 5, enables the EPs to be transferred from the dubbing source to the dubbing destination by setting the EPs in “Title_3” in the dubbing destination based on the information about the position of each of the EPs in “Title_1” in the dubbing source. On the assumption that EPs correspond to chapter boundaries as described above, transfer of EPs means transfer of the corresponding chapters from the dubbing source to the dubbing destination.

With rate-conversion dubbing, it is possible that a black screen is added before or after the title in the dubbing destination. Such a black screen may be added for the following reasons. For example, if a title that has been subjected to rate-conversion dubbing is to be recorded again in the DVD-Video format on a DVD-R or a DVD-RW so that the title can be reproduced on a conventional DVD player that does not support the DVD-VR standard, such a black screen is used to prevent an undesired screen that results from the title being handled in units of Group Of Picture (GOP) according to MPEG2. However, this black screen causes a screen gap to be generated between the dubbing source and the dubbing destination by an amount equivalent to the number of frames of the black screen added to the start of the title in the dubbing destination. In such a case, in the information recording and reproducing apparatus according to the present invention, the position at which each EP is to be set in the dubbing destination is shifted by an offset equivalent to the number of frames of the black screen to match the chapter boundaries in the dubbing source to those in the dubbing destination. In the example in FIG. 5, the five EPs “EP_1” to “EP_5” in “Title_1” in the dubbing source correspond to the EPs “EP_12” to “EP_16”, respectively, in “Title_3” in the dubbing destination. Thus, the positions at which the above-described “EP_12” to “EP_16” are set are shifted by an amount of “Offset” equivalent to the number of frames of the black screen added to the start of “Title_3”. If the PTM differences from the start of “Title_1” to the five EPs “EP_1” to “EP_5” in “Title_1” are represented as “Diff(EP_1)” to “Diff(EP_5)”, respectively, “EP_PTM12” to “EP_PTM16”, which are the PTMs at the positions where the five EPs “EP_12” to “EP_16” are set in “Title_3”, are obtained in the following manner.
EP_PTM12=“C_V_S_PTM3-1”+“Offset”+Diff(EP_1)
EP_PTM13=“C_V_S_PTM3-1”+“Offset”+Diff(EP_2))
EP_PTM14=“C_V_S_PTM3-1”+“Offset”+Diff(EP_3)
EP_PTM15=“C_V_S_PTM3-1”+“Offset”+Diff(EP_4)
EP_PTM16=“C_V_S_PTM3-1”+“Offset”+Diff(EP_5)

As described above, based on the information about the position of each of the five EPs “EP_1” to “EP_5” in “Title_0.1” and with the offset value “Offset” taken into consideration, the five EPs “EP_12” to “EP_16” are set in another title “Title_3”. In FIG. 5, in addition to “EP_12” to “EP_16”, “EP_11” is set at the start of “Title_3”. This “EP_11” may be omitted.

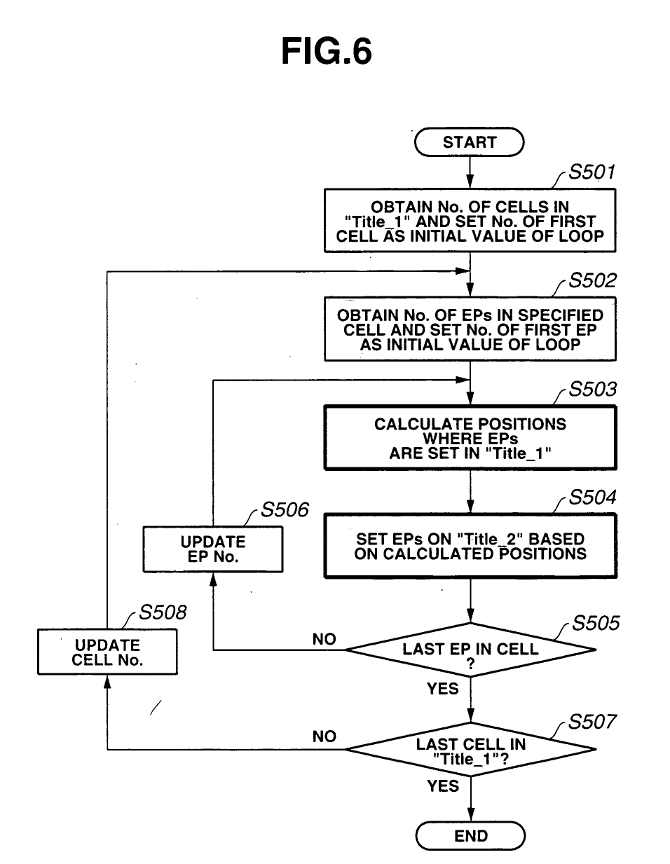

FIG. 6 is a flowchart of example processing for obtaining the positions where entry points are set in a certain title and for setting entry points in another title based on the obtained positions. In short, the flowchart in FIG. 6 corresponds to steps S404 and S405 in FIG. 4. In this example, the positions where EPs are set in “Title_1” are calculated, and based on the calculated positions EPs are set in “Title_2”. Furthermore, each time the position of an EP in “Title_1” is obtained, an EP is set in “Title_2”.

First, in step S501, the number of cells in “Title_1” is obtained. The number of cells determines the number of repetitions of the loop for the cells in “Title_1”. Furthermore, the number of the first cell in “Title_1” is set as the initial value for the loop for cells to specify the cell to be processed.

Next, in step S502, the number of EPs in the specified cell is obtained. The number of EPs determines the number of repetitions of the loop for EPs in the cell to be processed. Furthermore, the number of the first EP included in the cell to be processed is set as the initial value for the loop for EPs to specify the EP to be processed.

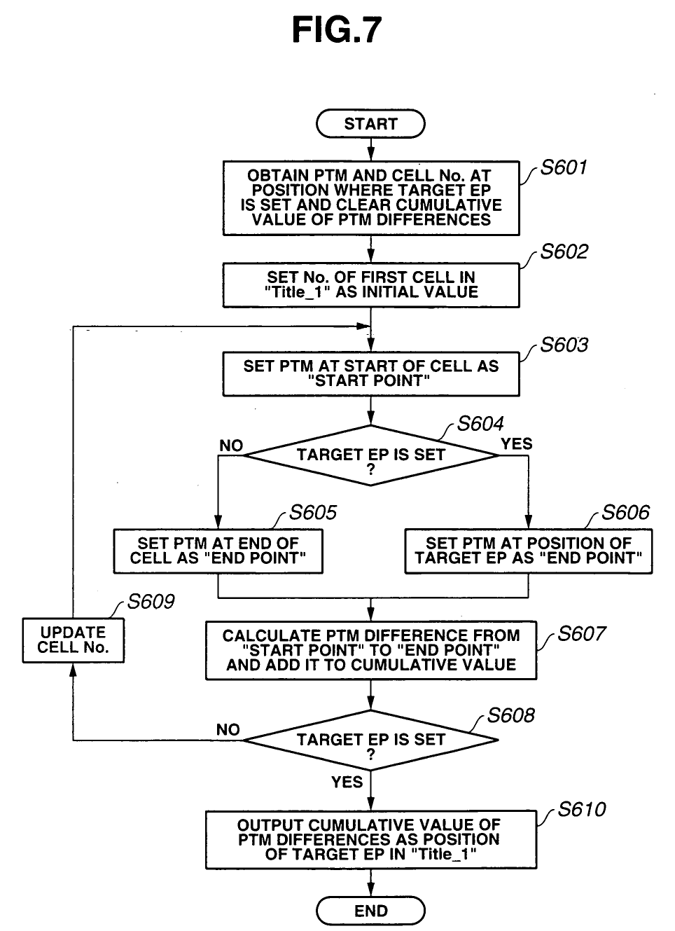

Next, in step S503, the position where the specified EP is set in “Title_1” is calculated. The processing in step S503 is described later in detail with reference to FIG. 7.

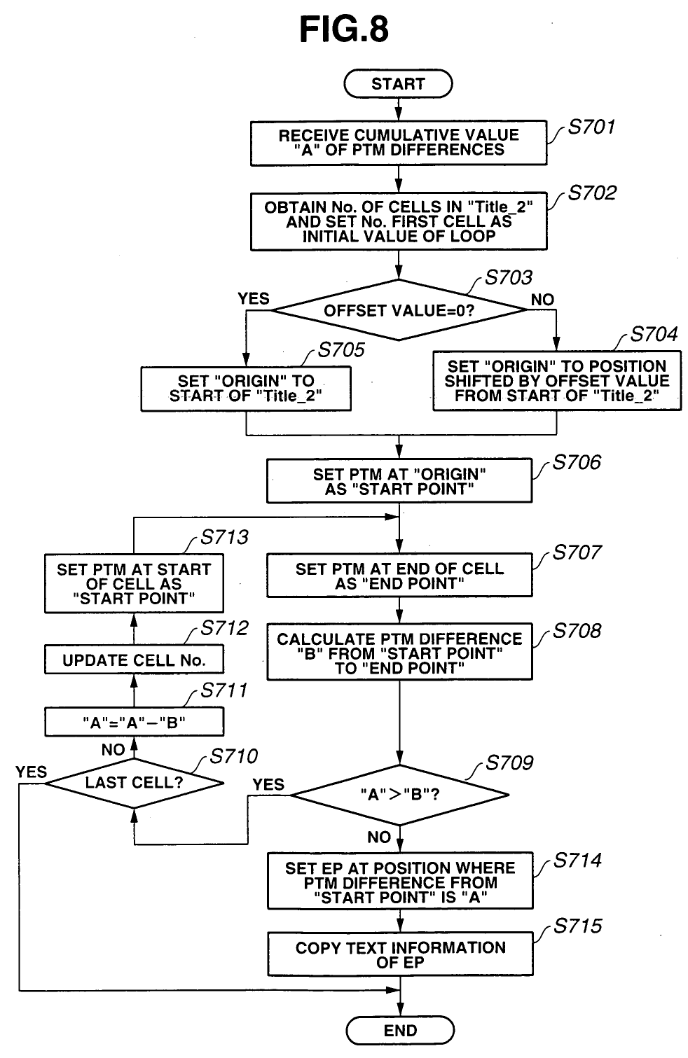

In step S504, an EP is set in “Title_2” based on the position information calculated in step S503. The processing in step S504 is described later in detail with reference to FIG. 8.

In step S505, it is determined whether the EP to be processed is the last EP in the cell. If the EP in question is not the last EP in the cell, the flow proceeds to steps 506, where the number of the EP to be processed is updated and then the series of processing steps from step S503 to step S505 is applied to the subsequent EP specified to be processed. On the other hand, if the EP in question is the last EP in the cell, the flow proceeds to step S507.

In step S507, it is determined whether the cell to be processed is the last cell in “Title_1”. If the cell in question is not the last cell in “Title_1”, the flow proceeds to steps 508, where the number of the cell to be processed is updated and then the series of processing steps from step S502 to step S507 is applied to the subsequent cell specified to be processed. On the other hand, if the cell in question is the last cell in “Title_1”, the entire series of processing steps ends.

FIG. 7 is a flowchart of example processing for calculating the positions where entry points are set in a certain title. This processing corresponds to the processing in step S503 of the flowchart in FIG. 6. In this example, the position where the EP specified to be processed is set in “Title_1” is calculated as a PTM difference relative to the start of “Title_1”. If “Title_1” contains a plurality of cells, the PTM difference from the start to the end of each cell is obtained, and the differences thus obtained are accumulated until the target EP is reached. Here, if the processing described in this flowchart in FIG. 7 is used for step S503 in FIG. 6, the PTM difference from the start of “Title_1” is calculated for every EP.

First, in step S601, the PTM (“EP_PTM”) at the position where the EP specified to be processed is set is obtained. The number of the cell where this target EP is set is also obtained. A variable storing the cumulative value of the PTM difference from the start of “Title_1” to the position where the target EP is set is also initialized.

Next, in step S602, to obtain the PTM difference for each cell, the number of the first cell included in “Title_1” is set as the initial value of the loop. If the processing described in this flowchart of FIG. 7 is used for step S503 in FIG. 6, step S503 of FIG. 6 is carried out as processing internal to the loop for cells in “Title_1”. This loop processing for cells in the flowchart of FIG. 7 differs from the loop processing in step S503 of FIG. 6.

In step S603, the PTM at the start of the cell for which the PTM difference is to be calculated is set as the “start point”.

In step S604, it is determined whether the cell for which the PTM difference is to be calculated corresponds to the cell where the EP specified as the target EP is set, and processing branches. If the cell for which the PTM difference is to be calculated does not correspond to the cell where the target EP is set, the flow proceeds to step S605, where the PTM at the end of this cell is set as the “end point”. In contrast, if the cell for which the PTM difference is to be calculated corresponds to the cell where the target EP is set, the flow proceeds to step S606, where the PTM at the position where the target EP is set is set as the “end point”.

Next, in step S607, the PTM difference from the “start point” to the “end point” set by the processing steps from step S604 to step S606 is calculated. Furthermore, this calculated PTM difference value is added to the variable storing the cumulative value of the PTM difference value obtained for each cell.

Thereafter, in step S608, it is determined whether the cell for which the PTM difference has just been calculated corresponds to the cell where the EP specified to be processed is set, and processing branches. If the cell for which the PTM difference has just been calculated does not correspond to the cell where the EP specified to be processed is set, the flow proceeds to step S609, where the number of the cell is updated and the series of processing steps from step S603 to step S608 is applied to the subsequent cell. In contrast, if the cell for which the PTM difference has just been calculated corresponds to the cell where the EP specified to be processed is set, the flow proceeds to step S610.

Since the cumulative value of the PTM difference values that have been calculated represents the PTM difference from the start of “Title_1”, in step S610 the series of processing steps ends by outputting the cumulative value as the position where the target EP is set in “Title_1”.

FIG. 8 is a flowchart of example processing for obtaining the positions where EPs are set in a certain title and for setting EPs in another title based on the obtained positions. This processing describes in detail the processing in step S504 of the flowchart in FIG. 6. In the processing of FIG. 8, EPs are set in “Title_2” based on the information about the positions where EPs in “Title_1” are set, as calculated in the flowchart of FIG. 7.

First, in step S701, the cumulative value of the PTM difference from the start of a certain title to the position where the EP is set in the title is input. Here, let “A” denote this cumulative value of the PTM difference. The value in step S701 is set as the initial value of the cumulative value “A” of the PTM difference.

Next, in step S702, the number of cells included in “Title_2” is obtained. The number of cells determines the number of repetitions of the loop for cells in “Title_2”. Furthermore, the number of the first cell included in “Title_2” is set as the initial value of the loop for cells to specify the cell to be processed.

In the subsequent step S703, it is determined whether the EP is to be set in “Title_2” by reflecting “Offset”, and processing branches. The offset value needs to have been specified before the processing in FIG. 8 is carried out. The offset value must be “0” or a positive value. If a non-zero positive value is specified as the offset value, the flow proceeds to step S704, where the “origin” is set to the position shifted by the offset value from the start of “Title_2”. Here, if the position shifted by the offset value from the start of “Title_2” is beyond the range of the cell set in step S702, the number of the cell where the “origin” set by shifting by the offset value exists is set as the initial value of the loop for cells. In contrast, if “0” is specified as the offset value, the flow proceeds to step S705, where the “origin” is set to the start of “Title_2”. In this case, it is needless to say that the start of the title corresponds to the cell set as the initial value of the loop for cells in step S702.

In step S706, the PTM at the “origin” set in step S704 or step S705 is set as the “start point”.

Next, in step S707, the PTM at the end of the current cell in the loop for cells is set as the “end point”.

In the subsequent step S708, the PTM difference from the “start point” to the “end point”, set by the processing in steps S706 and S707, is calculated. Let “B” denote this PTM difference value.

In the subsequent step S709, the cumulative value “A” of the above-described PTM difference calculated as the position where the EP is set in “Title_1” is compared with the PTM difference value “B” from the “start point” to the “end point” calculated in step S708. If the condition “A”>“B” is met, the flow proceeds to step S710. If the condition is not met, the flow proceeds to step S714. The processing in steps S710 and S714 will now be described.

First, if “A”>“B” is met in step S709, it is determined in step S710 whether the current cell in the loop for cells is the last cell included in “Title_2”. If the current cell in the loop for cells is the last cell included in “Title_2”, the series of processing steps ends. This applies to a case where the length of “Title_1” whose EP has been obtained is larger than the length of “Title_2” in which an EP is to be set, and furthermore, the position of the relevant EP in “Title_1” is beyond the length of “Title_2”. In contrast, if the current cell in the loop for cells is not the last cell included in “Title_2”, the flow proceeds to step S711.

In other words, the flow proceeds to step S711 if the position where an EP is to be set in “Title_2” is not in this cell. In step S711, the value generated by subtracting the PTM difference value “B” calculated in step S708 from the cumulative value “A” of the PTM difference is set to “A”, and then the flow proceeds to step S712.

In step S712, the number of the cell in the loop for cells included in “Title_2” is updated, and then the flow proceeds to step S713.

In step S713, the PTM at the start of the new cell is set as the “start point”.

Thereafter, using the updated value of “A”, the series of processing steps from S707 to step S709 is applied to the new cell.

On the other hand, in a case where the position where the EP is set in “Title_2” is in the current cell, the determination result in step S709 becomes “NO”, i.e., the flow proceeds to step S714. In this case, the remaining value of “A” represents the PTM difference value from the start of the current cell, and thus the EP is set at this position.

In the subsequent step S715, the series of processing steps ends by giving a copy of text information of the EP in “Title_1” to the new EP which has been set in “Title_2” in step S714.

Although the present invention has been described with reference to the attached drawings, it is noted that the present invention is not limited to the above-described embodiments. Instead, various modifications are conceivable within the scope of the present invention.

For example, according to the flowchart shown in FIG. 6, each time the position of an EP in “Title_1” is obtained, the corresponding EP is set in “Title_2”. Instead of this scheme, it is also possible to obtain the information about the positions of all EPs in “Title_1”, and then the corresponding EPs are set in “Title_2” all together.

Furthermore, if the processing described with reference to the flowchart in FIG. 7 is used for the processing in step S503 of the flowchart in FIG. 6, the information about the positions of all EPs in “Title_1” is calculated as the PTM difference value from the start of “Title_1”. Instead of calculating the PTM difference relative to the start of “Title_1”, it is also possible to calculate the PTM difference relative to the position of the preceding EP (i.e., the EP adjacent to the start of the title) in “Title_1”.

Furthermore, the copying of text information in step S715 of the flowchart in FIG. 8 can be omitted.

In addition, although in FIG. 5 “EP_11” is set at the start of “Title_3”, this “EP_11” can be omitted because it is not an EP whose position has been determined based on the position information calculated in “Title_1” plus the offset. Furthermore, specific text information, such as a text “black screen”, may be added to “EP_11, or “EP_11” needs not be assigned any text information.

With the section described in the embodiments according to the present invention, an EP can be set in one title at the same position of the corresponding EP in another title. Alternatively, an EP can be set at a position shifted by a specified offset in another title. As a result, when a title of the same content as the content of another title is to be produced with re-encoding, such as with rate-conversion dubbing, EPs in the source title can be transferred to the other title of the same content in the dubbing destination. In information recording and reproducing apparatuses where EPs defined in compliance with the DVD-VR standard are regarded as boundaries of chapters, i.e., segments in a title, chapters are lost as a result of rate conversion dubbing. According to the means described in the above-described embodiments, however, chapters are transferred from the dubbing source to the dubbing destination.

According to the embodiments of the present invention, dubbing processing is performed from a magnetic disk to an optical disk such as a DVD-RAM. The present invention is not limited to this type of dubbing, but can be applied to any type of dubbing processing from a general recordable medium to a general recordable medium, e.g., from an optical disk such as a DVD-RAM to a magnetic disk, from a magnetic disk to a magnetic disk, or from an optical disk such as a DVD-RAM to another optical disk such as a DVD-RAM. In addition, the present invention is not limited to a dedicated video recorder but is applicable to, for example, a system including a personal computer provided with an HDD drive and a DVD drive.

Having described the preferred embodiments of the invention referring to the accompanied drawings, it should be understood that the present invention is not limited to those precise embodiments and various changes and modifications thereof could be made by one skilled in the art without departing from the spirit or scope of the invention as defined in the appended claims.

1. An information recording and reproducing apparatus for dubbing content where the rate of the content is converted, comprising:
a section which decodes content in a dubbing source;
a section which encodes the decoded content at a predetermined conversion rate and produces content in a dubbing destination;
a section which verifies an entry point associated with the content in the dubbing source; and
a section which associates the verified entry point with the content in the dubbing destination.

2. An information recording and reproducing apparatus according to claim 1, further comprising:
a section which selects and determines a conversion rate;
wherein the decoded content is encoded at the selected conversion rate, thereby the content in a dubbing destination is produced.

3. The information recording and reproducing apparatus according to claim 1, wherein the associating section associates the verified entry point with the content in the dubbing destination where the entry point is shifted by a predetermined offset.

4. The information recording and reproducing apparatus according to claim 2, wherein the associating section associates the verified entry point with the content in the dubbing destination where the entry point is shifted by a predetermined offset.

5. An information recording and reproducing apparatus for dubbing actual video data of a first title as actual video data of a second title where the rate of the actual video data of the first title is converted, comprising:
a section which decodes the actual video data of the first title;
a section which encodes the decoded actual video data at a predetermined conversion rate and produces the actual video data of the second title;
a section which obtains information about a relative position of first point information, functioning as a mark, in the first title based on reference information referring to the actual video data of the first title; and
a section which establishes second point information, functioning as a mark, in the second title based on the obtained information about the relative position of the first point information wherein the second point information is associated with reference information referring to the actual video data of the second title.

6. An information recording and reproducing apparatus according to claim 5, further comprising:
a section which selects and determines a conversion rate;
wherein the decoded actual video data is encoded at the selected conversion rate, thereby the actual video data of the second title is produced.

7. An information recording and reproducing method for dubbing content where the rate of the content is converted, comprising:
decoding content in a dubbing source;
encoding the decoded content at a predetermined conversion rate and producing content in a dubbing destination;
verifying an entry point associated with the content in the dubbing source; and
associating the verified entry point with the content in the dubbing destination.

8. An information recording and reproducing method according to claim 7, further comprising:
selecting and determining a conversion rate;
wherein the decoded content is encoded at the selected conversion rate, thereby the content in a dubbing destination is produced.

9. The information recording and reproducing method according to claim 7, wherein, in the associating step, the verified entry point is associated with the content in the dubbing destination where the entry point is shifted by a predetermined offset.

10. The information recording and reproducing method according to claim 8, wherein, in the associating step, the verified entry point is associated with the content in the dubbing destination where the entry point is shifted by a predetermined offset.
